(19) United States
(12) Patent Application Publication
(10) Pub. No.: US 2024/0258934 A1
(43) Pub. Date: Aug. 1, 2024

(54) EXTENDING CAPACITOR LIFETIME IN A POWER CONVERTER

(71) Applicant: Eaton Intelligent Power Limited, Dublin (IE)

(72) Inventor: Huaqiang Li, Menomonee Falls, WI (US)

(21) Appl. No.: 18/393,144

(22) Filed: Dec. 21, 2023

Related U.S. Application Data
(60) Provisional application No. 63/441,251, filed on Jan. 26, 2023.

(51) Int. Cl. H02M 7/797; H02M 1/08

(52) U.S. Cl. CPC H02M 7/797; H02M 1/08

(57) ABSTRACT

A power converter includes: a filter system including a plurality of input nodes, each input node configured to electrically connect to one phase of a multi-phase AC electrical power distribution network; an electrical network including a plurality of intermediate nodes, each intermediate node electrically connected to one phase of the filter system, the electrical network configured to convert alternating current (AC) to direct current (DC), the electrical network including a plurality of electronic switches; a DC link electrically connected to the electrical network and configured to receive the DC current from the electrical network; and a control system configured to: estimate an unbalance metric at the intermediate nodes; and control the electronic switches to compensate for the estimated unbalance metric to thereby reduce an amplitude of a ripple current in the DC current.

### CROSS-REFERENCE TO RELATED APPLICATION

This application claims the benefit of U.S. Provisional Application No. 63/441,251, filed on Jan. 26, 2023 and titled EXTENDING CAPACITOR LIFETIME IN A POWER CONVERTER, which is incorporated herein by reference in its entirety.

### TECHNICAL FIELD

This disclosure relates to extending capacitor lifetime in a power converter that includes an active front end by compensating for voltage disturbances.

### BACKGROUND

An electrical apparatus, such as a variable speed drive, an adjustable speed drive, or an uninterruptable power supply, may be connected to an alternating current (AC) high-power electrical distribution system, such as a power grid. The electrical apparatus drives, powers, and/or controls a machine, or a non-machine type of load. The electrical apparatus includes an electrical network that converts AC power to direct-current (DC) power.

### SUMMARY

In one aspect, a power converter includes: a filter system including a plurality of input nodes, each input node configured to electrically connect to one phase of a multi-phase AC electrical power distribution network; an electrical network including a plurality of intermediate nodes, each intermediate node electrically connected to one phase of the filter system, the electrical network configured to convert alternating current (AC) to direct current (DC), the electrical network including a plurality of electronic switches; a DC link electrically connected to the electrical network and configured to receive the DC current from the electrical network; and a control system configured to: estimate an unbalance metric at the intermediate nodes; and control the electronic switches to compensate for the estimated unbalance metric to thereby reduce an amplitude of a ripple current in the DC current.

Implementations may include one or more of the following features.

The unbalance metric may be an estimate of an amount of voltage unbalance.

The unbalance metric may include an estimate of a negative sequence voltage at the intermediate nodes. The unbalance metric may include an estimate of a d-axis component of the negative sequence voltage and a q-axis component of the negative sequence voltage.

The control system also may be configured to: determine a d-axis component of an AC current that flows in the intermediate nodes of the power converter; and determine a q-axis component of an AC current that flows in the intermediate nodes of the power converter, and, the control system may estimate the unbalanced metric based on the d-axis component of the AC current that flows in the intermediate nodes and the q-axis component of the AC current that flows in the intermediate nodes. The control system also may be configured to estimate a d-axis positive sequence voltage component, a q-axis positive sequence voltage component, a d-axis negative sequence voltage component, and a q-axis negative sequence voltage component based on the d-axis component of the AC current that flows in the intermediate nodes and the q-axis component of the AC current that flows in the intermediate nodes; and the control system may estimate the unbalanced metric based on the d-axis positive sequence voltage component, the q-axis positive sequence voltage component, the d-axis negative sequence voltage component, and the q-axis negative sequence voltage component.

The electrical network may include a rectifier, and each of the plurality of electronic switches may be a transistor.

The electrical network may be configured to convert DC power to AC power such that the power converter is a bi-directional power converter.

In another aspect, a control system for a power converter includes: an observer block configured to estimate a voltage disturbance in an active front end; a first control block configured to determine a DC reference current based on a reference voltage for an energy storage apparatus and a measured voltage across the energy storage apparatus; a second control block configured to determine a voltage reference based on the determined DC reference current; a junction configured to subtract the estimated voltage disturbance from the determined voltage reference to determine a voltage control signal; and a third control block configured to generate a switch control signal based on the voltage control signal and to provide the switch control signal to an active front end to reduce a ripple current in a rectified current produced by the active front end.

Implementations may include one or more of the following features.

The observer block may be configured to estimate the voltage disturbance based on d-axis and q-axis component of an AC current input to the active front end, and the observer may estimate the voltage disturbance in the active front end based on the d-axis and q-axis components of the AC current input to the active front end. The estimate of the voltage disturbance may include a d-axis positive sequence voltage component, a q-axis positive sequence voltage component, a d-axis negative sequence voltage component, and a q-axis positive sequence voltage component.

The first control block may be configured to determine the voltage reference based on the reference voltage for the DC link, the measured voltage of the DC link, and a feedforward term.

The third control block may be a space vector pulse width modulation (SVPWM) control block.

In another aspect, positive and negative sequence components of a voltage disturbance in a power converter that is configured to provide a rectified current to an energy storage apparatus are estimated; a voltage control signal is determined based on the estimated voltage disturbance and a reference voltage; a switch control signal is estimated based on the voltage control signal; and the switch control signal is applied to the power converter to thereby reduce a ripple current in the rectified current provided to the energy storage apparatus.

The estimated voltage disturbance may include a d-axis positive sequence voltage component, a q-axis positive sequence voltage component, a d-axis negative sequence voltage component, and a q-axis positive sequence voltage component; and the reference voltage may include a d-axis reference voltage component and a q-axis reference component.

Implementations of any of the techniques described herein may include an apparatus, a device, a system, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power system.

FIG. 2A is a schematic of a system.

FIG. 2B is a schematic of a three-phase AC electrical power distribution network.

FIG. 3 is a block diagram of a control scheme.

FIG. 4 is a block diagram of the angle determination block.

FIG. 5 is a flow chart of a process for compensating for voltage unbalance.

FIGS. 6-8 show simulated data.

### DETAILED DESCRIPTION

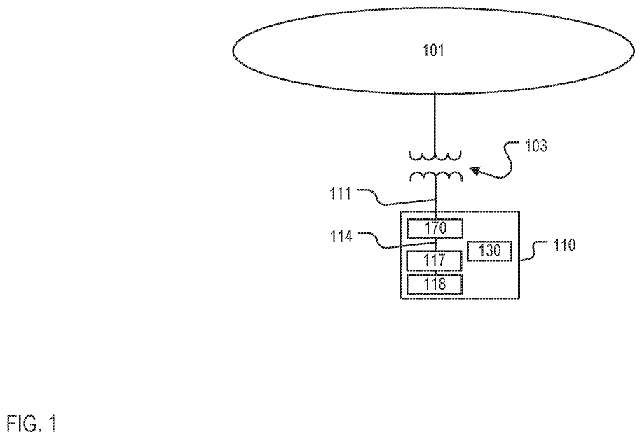

FIG. 1 is a block diagram of an example of a power system 100. The power system 100 includes a power converter 110 that is electrically connected to a power distribution network 101 at an input node 111. The power converter 110 includes a filter system 170, a rectifier 117, a DC link 118, and a control system 130. The filter system 170 is between the input node 111 and an intermediate node 114. The rectifier 117 is made of controllable electronic switches, and the control system 130 controls the state of the controllable electronic switches. The control system 130 controls the controllable electronic switches in the rectifier 117 to convert alternating current (AC) or time-varying power from the power distribution network 101 to direct current (DC) power that is provided to the DC link 118. The control system 130 also implements an observer control scheme that estimates an amount of voltage disturbance (for example, voltage imbalance) at the intermediate node 114 and controls the switches in the rectifier 117 to compensate for the estimated voltage disturbances.

The electrical power distribution network 101 may be, for example, a three-phase electrical power grid that provides electricity to industrial, commercial, and/or residential facilities. The AC electrical power distribution network 101 distributes AC electrical power that has a fundamental frequency of, for example, 50 or 60 Hertz (Hz). The distribution network 101 may have an operating voltage of, for example, up to 1 kilovolt (kV), at least 1 kV, 12 kV, up to 34.5 kV, up to 38 kV, or 69 kV or higher. In the example of FIG. 1, the power system 100 includes a transformer 103 between the input node 111 and the electrical power distribution network 101. The transformer 103 steps-down or reduces the voltage of the distribution network 101 such that the AC voltage at the input node 111 is lower than the voltage of the distribution network 101. For example, the voltage at the input node 111 may be 480 V.

Although the AC power in the electrical power distribution network 101 is nominally sinusoidal, in practice, the electrical power distribution network 101 includes power quality disturbances such as unbalanced voltages. Unbalanced voltage occurs in a poly-phase system when the individual phase voltages differ in amplitude and/or are displaced from their normal phase relationship. For example, an unbalanced voltage condition exists in a three-phase system when the phase voltages are not displaced from each other by 120°. In another example, an unbalanced voltage condition exists in a three-phase system when the root-mean-square (RMS) voltage of at least one phase is different from the RMS voltage of the other two phases by more than a threshold amount. Voltage unbalances can cause ripples in the nominally DC current that flows into the DC link 118 and ripples in the nominally DC voltage across the DC link 118. A ripple is a time-varying or AC component of a nominally DC voltage or current. These ripple currents and voltages cause additional heating in the capacitor of the DC link 118 and shorten the life of the capacitor and the DC link 118.

On the other hand, the control system 130 estimates an unbalance metric that characterizes the voltage unbalance and controls the switches in the rectifier 117 to compensate for the voltage unbalance. By compensating for the voltage unbalance, the control system 130 also reduces or eliminates the ripple in the voltage and/or current in the DC link 118, thereby extending the lifetime of the DC link 118. The capacitor(s) in the DC link 118 are typically the most common or one of the most common points of failure in a power converter. Thus, by extending the lifetime of the capacitor(s) in the DC link 118, the control system 130 also extends the lifetime of the power converter 110 and mitigates one of the largest sources of power converter failure.

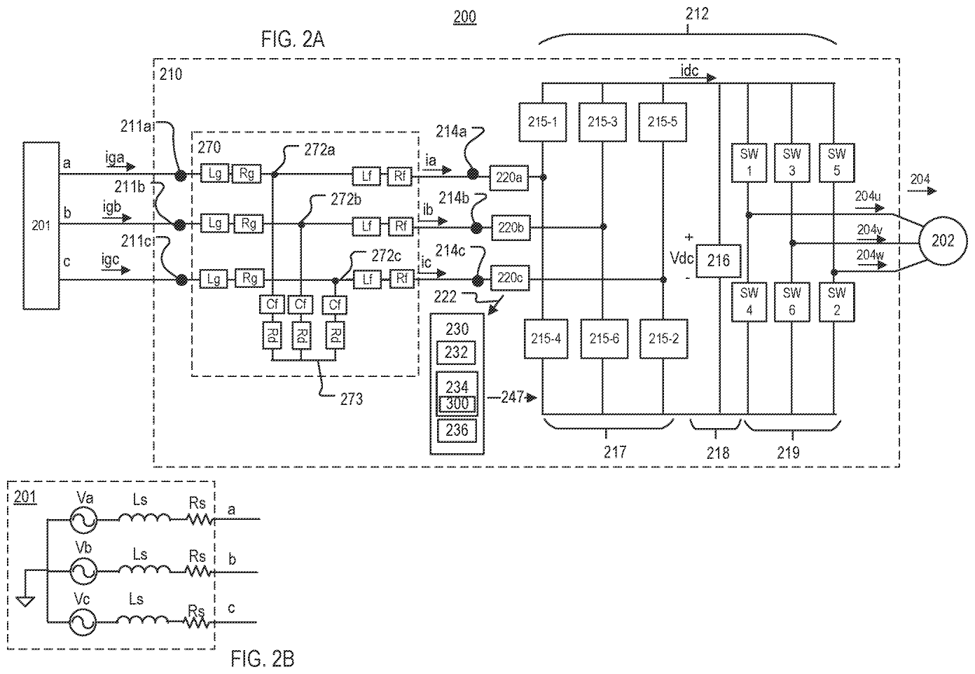

FIG. 2A is a schematic of a system 200. FIG. 2B is a schematic of a three-phase AC electrical power distribution network 201. The system 200 includes a power converter 210 that is connected to a load 202 and a three-phase AC electrical power distribution network 201. The load 202 may be, for example, an induction motor or a permanent magnet synchronous machine. The system 200 also includes a control system 230 that implements a control scheme 300 to compensate for voltage unbalances. The dashed lines in FIG. 2A are used to show groupings of elements, and the dashed lines do not necessarily represent physical objects. However, the power converter 210 may be in a housing or enclosure, such as a rack-mountable box or a cabinet.

The electrical power distribution network 201 distributes AC electrical power that has a fundamental frequency of, for example, 50 or 60 Hertz (Hz). The distribution network 201 may include, for example, one or more transmission lines, distribution lines, electrical cables, and/or any other mechanism for transmitting electricity. The distribution network 201 includes three phases, which are referred to as a, b, and c. Each phase a, b, c has a respective grid voltage Va, Vb, Vc (FIG. 2B). The impedance of the distribution network 201 is represented by an inductor Ls in series with a resistance Rs. The impedance of the distribution network 201 depends on the impedance characteristics of the components included in the distribution network 201.

The power converter 210 includes input nodes 211a, 211b, 211c, each of which is electrically coupled to one of the three phases (a, b, c) of the distribution network 201. The power converter 210 also includes an LCL filter 270. The LCL filter system 270 includes inductors and capacitors, and may or may not include additional electronic components. For example, the LCL filter system 270 also includes damping resistors Rf. The LCL filter system 270 includes three LCL filters, one for each phase a, b, c. In phase a, the LCL filter 270 is connected between the input node 211a and an intermediate node 214a. The intermediate node 214a may be considered an input node of the electrical network 212. The LCL filter in phase a includes a grid-side inductor Lg, a converter-side inductor Lf, a filter capacitor Cf, and a damping resistor Rf in series with the filter capacitor Cf. The resistance of the converter-side inductor Lf is represented by an impedance Rf in series with the converter-side inductor Lf. The resistance of the grid-side inductor Lg is represented by an impedance Rg in series with the grid-side inductor Lg.

The grid-side inductor Lg is electrically connected to the input node 211a, and the converter-side inductor Lf is connected to the node 214a. The series combination of the filter capacitor Cf and the damping resistor Rd is connected to a node 272a, which is between the converter-side inductor Lf and the grid-side inductor Lg, and to a node 273. The input node 211b is connected to phase b of the LCL filter 270, and the input node 211c is connected to phase c of LCL filter 270. Each of phases b and c of the LCL filter is configured in the same manner as phase a. The series combination of the filter capacitor Cf and the damping resistor Rd of phase b is connected to a node 272b and the node 273, and the series combination of the filter capacitor Cf and the damping resistor Rd of phase c is connected to a node 272c and the node 273, as shown in FIG. 2A.

The power converter 210 includes an electrical network 212 that includes a rectifier 217, a DC link 218, and an inverter 219. The control scheme 300 observes the AC electrical current ia, ib, ic that flows in a respective intermediate node 214a, 214b, 214c and estimates the voltage disturbance at each intermediate node 214a, 214b, 214c. As discussed further below, the control system 230 controls the rectifier 217 in a manner that compensates for the voltage disturbance. An overview of the operation of the power converter 210 is discussed before discussing the control system 230 and the control scheme 300 in more detail.

The rectifier 217 is a three-phase, active front end (AFE) that includes six electronic switches 215-1 to 215-6 that rectify the AC currents ia, ib, ic into a DC current idc. The electronic switches 215-1 to 215-6 are any type of controllable electronic switch. For example, each switch 215-1 to 215-6 may be a transistor, such as, for example, an insulated gate bipolar transistor (IGBT) or a metal-oxide semiconductor field effect transistor (MOSFET). Each electronic switch 215-1 to 215-6 has an ON state that conducts current and an OFF state that does not conduct current. The state of each electronic switch 215-1 to 215-6 is controlled by the control system 230. For example, in implementations in which the switches 215-1 to 215-6 are transistors, the control system 230 may control the state of a particular transistor 215-1 to 215-6 by controlling the voltage at the gate of that transistor. The control system 230 may be configured to control the electronic switches 215-1 to 215-6 based on a pulse width modulation (PWM) control scheme.

The electronic switches 215-1 to 215-6 are also electrically connected to the DC link 218, which includes an energy storage apparatus 216. The energy storage apparatus 216 is any component that is capable of storing electrical energy. The energy storage apparatus 216 may be, for example, a capacitor, or a network made of a collection of such devices. In some implementations, the energy storage apparatus 216 includes one or more electrolytic capacitors. The rectified current idc flows into the energy storage apparatus 216 and is stored.

The inverter 219 modulates the DC power stored in the energy storage apparatus 216 into three-phase AC driver signal 204 that is provided to the load 202. The three-phase driver signal 204 has phase components 204u, 204v, 204w, each of which is provided to one of the three phases of the load 202. The inverter 219 includes a network of electronic switches SW1-SW6 that are arranged to generate the driver signal 204. Each of the switches SW1-SW6 may be, for example, a power transistor.

The discussion above relates to generating the AC driver signal 204 and providing the AC driver signal 204 to the load 202. However, the power converter 210 may be bi-directional. In implementations in which the power converter 210 is bi-directional, the control system 230 also controls the electronic switches 215-1 to 215-6 and SW1-SW6 such that power can flow from the load 202 to the grid 201. Thus, energy generated by the load 202 may be returned to the grid 201 through the bi-directional power converter 210. Furthermore, the power converter 210 is provided as an example, and other configurations are possible. For example, the bi-directional power converter 210 may be implemented without the inverter 219 and configured to drive a DC load.

The system 200 also includes the sensors 220a, 220b, 220c that measure one or more electrical properties at the respective node 214a, 214b, 214c. The sensors may include voltage sensors and/or current sensors (for example, hall-effect sensors, current transformers, and/or Rogowski coils). The sensors 220a, 220b, 220c produce data 222, which includes an indication of one more electrical properties of the power that flows at the respective nodes 214a, 214b, 214c. For example, the sensors 220a, 220b, 220c may produce numerical values that represent values of measured current and/or voltage at the nodes 214a, 214b, 214c. The system 200 also includes additional sensors. For example, the system 200 includes one or more sensors that measure the value of idc and/or Vdc (the voltage across the energy storage apparatus 216) and one or more sensors that measure the value of Va, Vb, Vc (the voltage at the input nodes 211a, 211b, 211c).

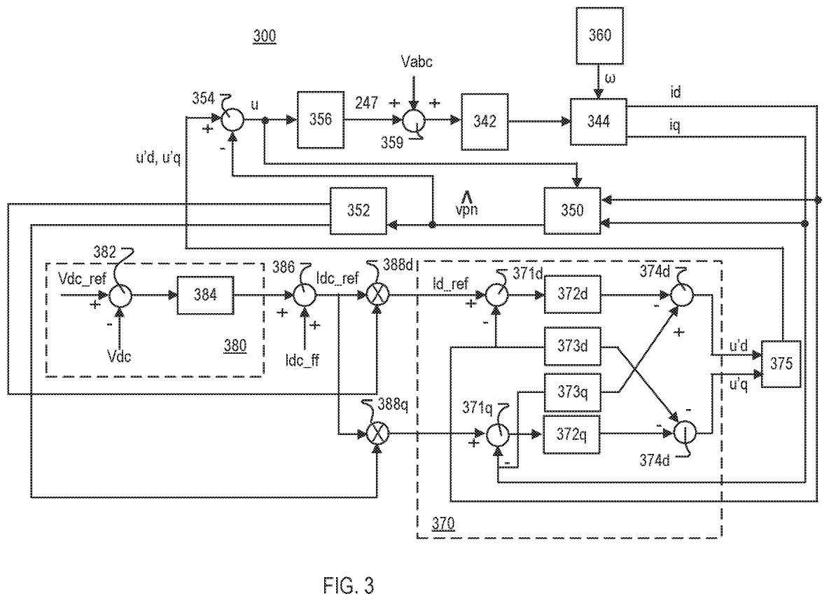

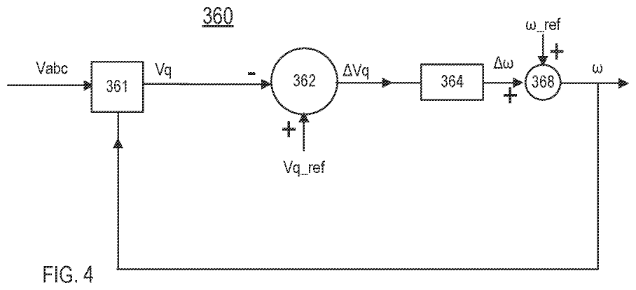

The control system 230 is coupled to the sensors and analyzes the data produced by the sensors. The control system 230 estimates an amount of voltage disturbance at the intermediate nodes 24a, 214b, 214c and produces a control signal 247 for the rectifier 217. The control signal 247 is generated based on a control scheme, as discussed in greater detail with respect to FIGS. 3 and 4. The control signal 247 controls the state of one or more of the switches 215-1 to 215-6 such that the switches 215-1 to 215-6 generate a waveform that cancels the voltage distortion at the intermediate nodes 214a, 214b, 214c, thereby reducing, minimizing, or eliminating ripple in idc and/or Vdc.

The control system 230 includes an electronic processing module 232, an electronic storage 234, and an input/output (I/O) interface 236. The electronic processing module 232 includes one or more electronic processors. The electronic processors of the module 232 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 234 may be any type of electronic memory that is capable of storing data and instructions in the form of computer programs or software, and the electronic storage 234 may include volatile and/or non-volatile components. The electronic storage 234 and the processing module 232 are coupled such that the processing module 232 is able to access or read data from and write data to the electronic storage 234. The electronic storage 234 stores instructions that, when executed, cause the electronic processing module 232 to analyze data and/or retrieve information. For example, the electronic storage 234 includes instructions that cause the processing module 232 to analyze the data 222. In another example, the electronic storage 234 includes instructions in the form of software, subroutines, and/or functions that implement the control scheme 300 of FIG. 3. The electronic storage 234 also stores parameters that are used in the control scheme 300. For example, the electronic storage 234 may store default and/or pre-defined values of various target voltage and/or currents and various other target values.

The I/O interface 236 is any interface that allows a human operator, another device, and/or an autonomous process to interact with the control system 230. The I/O interface 236 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 236 also may allow communication without physical contact through, for example, an IEEE 802.11, Bluetooth, or a near-field communication (NFC) connection. The control system 230 may be, for example, operated, configured, modified, or updated through the I/O interface 236. For example, in some implementations, an operator may enter values for various parameters for the control scheme 300 through the I/O interface 236.

The I/O interface 236 also may allow the control system 230 to communicate with components in the system 200 and with systems external to and remote from the system 200. For example, the I/O interface 236 may include a communications interface that allows communication between the control system 230 and a remote station (not shown), or between the control system 230 and a separate monitoring apparatus. The remote station or the monitoring apparatus may be any type of station through which an operator is able to communicate with the control system 230 without making physical contact with the control system 230. For example, the remote station may be a computer-based work station, a smart phone, tablet, or a laptop computer that connects to the motor control system 230 via a services protocol, or a remote control that connects to the control system 230 via a radio-frequency signal.

FIG. 3 is a block diagram of the control scheme 300. In the discussion below, the control scheme 300 is implemented by the control system 230 and is part of the system 200. However, the control scheme 300 may be used with any rectifier that includes controllable switches.

A three-phase voltage may be represented as a sum of a positive sequence component and a negative sequence component. The positive sequence component represents three equal phasors that are generated by the system voltage and phase displaced by 120°. The negative sequence component represents three equal phasors that are not generated by the system voltage and are phase displaced by 120° with each other. In a balanced three-phase system, only the positive sequence component is non-zero. When the three-phase system is unbalanced, the negative sequence component is non-zero. The control scheme 300 includes an observer 350 that estimates the positive and negative sequence components of the voltage at the intermediate nodes 214a, 214b, 214c. The negative sequence component provides an estimate of voltage disturbances at the intermediate nodes 214a, 214b, 214c caused by the grid 201. The control scheme 300 determines the control signal 247 that, when applied to the rectifier 217, compensates for the voltage unbalance.

The control scheme 300 includes a filter block 342 that models the LCL filter system 270. The input to the filter block 342 is an indication of the measured three-phase voltage Vabc at the input nodes 211a, 211b, 211c. For example, the indication of the measured AC grid voltage at each of the input nodes 211a, 211b, 211c may be information, such as numerical data, that indicates the amplitude of the instantaneous voltage measured by a sensing system coupled to the input nodes 211a, 211b, 211c at a particular time. The output of the filter block 342 is the three-phase current ia, ib, ic that flows in the respective intermediate node 214a, 214b, 214c.

The three-phase current ia, ib, ic is provided to a transformation block 344 that transforms the three-phase current ia, ib, ic into d-axis and q-axis components using the Clarke and Park transformations. The Clarke transformation projects a three-phase quantity (such as the three-phase current ia, ib, ic) onto a two-dimensional stationary coordinate system defined by two orthogonal axes: an α axis and a β axis. The Park transformation rotates the stationary α, β axes at a frequency ω to determine the d-axis and q-axis components. The frequency ω is the phase angle of the grid 201 expressed in radians. The combined Clarke and Park transformation is shown in Equation (1):

$$[ \begin{matrix}i d \\ i q \\ i 0\end{matrix} ] = \frac{2}{3} [ \begin{matrix}sin ( ω t ) & sin ( ω t - \frac{2 π}{3} ) & sin ( ω t + \frac{2 π}{3} ) \\ cos ( ω t ) & cos ( ω t - \frac{2 π}{3} ) & cos ( ω t + \frac{2 π}{3} ) \\ \frac{1}{2} & \frac{1}{2} & \frac{1}{2}\end{matrix} ] [ \begin{matrix}ia \\ ib \\ ic\end{matrix} ] , \qquad Equation ( 1 )$$

where ia, ib, ic are the currents that flow in the intermediate nodes 214a, 214b, 214c, respectively, id is the d-axis current component (or direct current component), and iq is the q-axis current component (or quadrature current component). The phase angle (ω) of the grid 201 is determined by an angle determination block 360 that implements a phase-locked loop that detects the phase angle of the grid 201.

Referring also to FIG. 4, a block diagram of the angle determination block 360 is shown. The angle determination block 360 implements a phase-locked loop (PLL) technique to determine or detect the angle ω. The angle determination block 360 includes a transformation module 361 that receives Vabc. The transformation block 344 converts the indications of the instantaneous voltage at the input nodes 211a, 211b, 211c into a voltage component on the d-axis (Vd) and a voltage component on the q-axis (Vq). For example, the transformation module 361 may implement the Clarke transformation followed by the Park transformation as shown in Equation (1), to find the d-axis and q-axis components of the grid 3-phase voltage Vabc.

The Vq current component is compared to a target value Vq_ref at a comparator 362 to determine an error value (ΔVq). The target value Vq_ref is a constant and may be zero. The target value Vq_ref may be stored on the electronic storage 234 or input via the I/O interface 236. The comparator 362 may be implemented in software or hardware, and the comparator 362 is configured to determine an absolute value of the difference between the target value Vq_ref and the Vq voltage component.

The angle determination block 360 also includes a proportional-integral control (PI) module 364, as shown in Equation (2):

$$Δ w = Kp + \frac{Ki}{s} , \qquad Equation ( 2 )$$

where Δω is estimate of the grid voltage angular frequency change, Kp is a proportional gain constant, and Ki is an integral gain constant. The PI control module 364 regulates ΔVq to the target value Vq_ref, which may be 0.

The angle determination block 360 also includes an adder 368 that adds the estimate of the grid voltage angular frequency change (Δω) to a reference angular frequency (ω_ref). The reference angular frequency is set to the value of the grid 201 fundamental frequency (for example, 2*π*60 for implementations in which the grid 201 has a fundamental frequency of 60 Hz). The output of the adder 368 is an estimate of the grid voltage phase angle (ω) and is provided to the transformation block 344.

Referring again to FIG. 3, the outputs of the transformation block 344 are id and iq, which are the d-axis and q-axis current components, respectively, of the three-phase current that flows in the intermediate nodes 214a, 214b, 214c. The d-axis current component (id) and the q-axis current component (iq) are provided to an observer 350 and to the current controller 370.

The observer 350 predicts or estimates a voltage ( [symbol] ) based on the d-axis current (id) and the q-axis current (iq). The voltage ( [symbol] ) includes four individual estimated voltages: an estimate of the d-axis positive sequence voltage ( [symbol] ), an estimate of the d-axis negative sequence voltage ( [symbol] ), an estimate of the q-axis positive sequence voltage ( [symbol] ), and an estimate of the q-axis negative sequence voltage ( [symbol] ). As discussed above, in a balanced three-phase system, only the positive sequence voltage components are non-zero. Thus, the estimates of the negative sequence d-axis ( [symbol] ) and q-axis voltages ( [symbol] ) provide an estimate of the voltage unbalance caused by the grid 201.

The voltage at the intermediate nodes 214a, 214b, 214c is assumed to behave as a linear system with the following state-space equations:

$$\dot{x} = A \cdot x + B \cdot u , \qquad Equation ( 3 )$$

$$y = C \cdot x + D \cdot u , \qquad Equation ( 4 )$$

where x is a state-space vector, A is a matrix that maps x to its derivative and captures the dynamics of the modeled system without external inputs, u is a control input, B is a gain matrix for the control input u, y is the observation vector (id and iq in this example), and Du is a direct map from input to output and is zero (0) for this modeled system. Equations for these variables are provided below. The observer 350 estimates the voltage ( [symbol] ) and is implemented according to Equation (5):

$$\dot{\hat{x}} = A \cdot \hat{x} + B \cdot u + K \cdot ( y - C \cdot \hat{x} ) , \qquad Equation ( 5 )$$

where K is selected to achieve zero (0) steady state error between \hat{x} and x, and x is given by Equation (6):

$$\dot{x} = {[ \begin{matrix}{i}_{d} & {i}_{q} & {v}_{d}^{p} & {v}_{q}^{p} & {v}_{d}^{n} & {v}_{d}^{{}^{.} n} & {v}_{q}^{n} & {v}_{q}^{{}^{.} n}\end{matrix} ]}^{T} , \qquad Equation ( 6 )$$

where id is the d-axis current determined by the transformation block 344, iq is the q-axis current determined by the transformation block 344, v_{d}^{p} is the positive sequence voltage in the d-axis, v_{d}ⁿ is the negative sequence voltage in the d-axis, v_{q}^{p} is the positive sequence voltage in the q-axis, v_{q}ⁿ is the negative sequence voltage in the q-axis, and the derivative of x is given by Equation (7):

$$\dot{x} = {[ \begin{matrix}{ι}_{d}^{.} & {ι}_{q}^{.} & {v}_{d}^{{}^{.} p} & {v}_{q}^{{}^{.} p} & {v}_{d}^{{}^{.} n} & {v}_{d}^{{}^{..} n} & {v}_{q}^{{}^{.} n} & {v}_{q}^{{}^{..} n}\end{matrix} ]}^{T} , \qquad Equation ( 7 )$$

the matrix A has eight sub-matrices (A₁ to A₈) and is shown in Equation (8):

$$A = {[ \begin{matrix}{A}_{1} & {A}_{2} & {A}_{3} & {A}_{4} & {A}_{5} & {A}_{6} & {A}_{7} & {A}_{8}\end{matrix} ]}^{T} , \qquad Equation ( 8 )$$

and the matrix B is given by Equation (9):

$$B = {[ \begin{matrix}{B}_{1} & {B}_{2}\end{matrix} ]}^{T} . \qquad Equation ( 9 )$$

The eight sub-matrices (A₁ to A₈) of the matrix A are shown in Equations (10) to (17):

$$\\ \begin{matrix}{A}_{1} = [ \begin{matrix}\frac{- R}{L} & - {ω}_{1} & \frac{1}{L} & 0 & \frac{1}{L} & 0 & 0 & 0\end{matrix} ] , & Equation ( 10 )\end{matrix}$$

where R is the resistance of the converter side inductor (labeled Rf in FIG. 2A), L is the inductance of the converter side inductor (labeled Lf in FIG. 2A), and ω is the frequency of the grid 201 in radians,

$$\\ \begin{matrix}{A}_{2} = [ \begin{matrix}- {ω}_{1} & \frac{- R}{L} & 0 & \frac{1}{L} & 0 & 0 & \frac{1}{L} & 0\end{matrix} ] , & Equation ( 11 )\end{matrix}$$

$$\\ \begin{matrix}{A}_{3} = [ \begin{matrix}0 & 0 & 0 & 0 & 0 & 0 & 0 & 0\end{matrix} ] , & Equation ( 12 )\end{matrix}$$

$$\\ \begin{matrix}{A}_{4} = [ \begin{matrix}0 & 0 & 0 & 0 & 0 & 0 & 0 & 0\end{matrix} ] , & Equation ( 13 )\end{matrix}$$

$$\\ \begin{matrix}{A}_{5} = [ \begin{matrix}0 & 0 & 0 & 0 & 0 & 1 & 0 & 0\end{matrix} ] , & Equation ( 14 )\end{matrix}$$

$$\\ \begin{matrix}{A}_{6} = [ \begin{matrix}0 & 0 & 0 & 0 & 2 {ω}^{{}_{} 2} & 0 & 0 & 0\end{matrix} ] , & Equation ( 15 )\end{matrix}$$

$$\\ \begin{matrix}{A}_{7} = [ \begin{matrix}0 & 0 & 0 & 0 & 0 & 0 & 0 & 1\end{matrix} ] , and & Equation ( 16 )\end{matrix}$$

$$\\ \begin{matrix}{A}_{8} = [ \begin{matrix}0 & 0 & 0 & 0 & 0 & 0 & 0 & 2 {ω}^{{}_{} 2}\end{matrix} ] . & Equation ( 17 )\end{matrix}$$

The matrix B includes two sub-matrices (B1 and B2) as shown in Equations (18) and (19):

$$\\ \begin{matrix}{B}_{1} = [ \begin{matrix}\frac{- 1}{L} & 0 & 0 & 0 & 0 & 0 & 0 & 0\end{matrix} ] , & Equation ( 18 )\end{matrix}$$

and

$$\\ \begin{matrix}{B}_{2} = [ \begin{matrix}0 & \frac{- 1}{L} & 0 & 0 & 0 & 0 & 0 & 0\end{matrix} ] . & Equation ( 19 )\end{matrix}$$

The matrix C is given by:

$$\\ \begin{matrix}C = [ \begin{matrix}1 & 0 & 0 & 0 & 1 & 0 & 0 & 0 \\ 0 & 1 & 0 & 0 & 0 & 1 & 0 & 0\end{matrix} ] , and & Equation ( 20 )\end{matrix}$$

$$\\ \begin{matrix}D = [ \begin{matrix}0 & 0 \\ 0 & 0\end{matrix} ] . & Equation ( 21 )\end{matrix}$$

The estimated voltage ( [symbol] ) is provided to a control block 352 and to a summing junction 354. The control block 352 estimates a d-axis voltage metric ( [symbol] ) and a q-axis voltage metric ( [symbol] ) from the estimated voltage ( [symbol] ) as shown in Equations 22 and 23, respectively:

$$\\ \begin{matrix}= - & Equation ( 22 )\end{matrix}$$

$$\\ \begin{matrix}= - . & Equation ( 23 )\end{matrix}$$

The control scheme 300 also includes a voltage controller 380 and a current controller 370. The voltage controller 380 determines reference values for the current controller 370. The current controller 370 determines d-axis and q-axis voltage reference command values (u′d and u′q).

The voltage controller 380 includes a comparator 382, a PI control block 384, and a summing junction 386. The inputs to the voltage controller 380 are Vdc_ref, which is a reference or target value for the voltage across the energy storage apparatus 216; and Vdc, which is a measured or actual voltage value for Vdc. The value of Vdc_ref may be stored on the electronic storage 234 and accessed by the control scheme 300 or provided to the control scheme 300 via the I/O interface 236. The measured voltage value Vdc may be an output of a sensor, such as a voltage meter, that measures the voltage across the energy storage apparatus 216.

The comparator 382 determines the error or difference (ΔVdc) between the measured or actual value of Vdc and Vdc_ref by subtracting Vdc from Vdc_ref. The error (ΔVdc) is input to a PI control block 384. The PI controller 384 regulates and reduces ΔVdc to a target value, which may be zero (0). The PI controller 384 may be implemented based on Equation (24):

$$\\ \begin{matrix}Kpv + \frac{Kiv}{s} , & Equation ( 24 )\end{matrix}$$

where Kpv and Kiv are gain constants that each have a numerical value that is greater than zero.

The output of the PI controller 384 is provided to the summing junction 386, which adds the output of the PI controller 384 to a feedforward term Idc_ff. The feedforward term Idc_ff represents the load level that the power converter 110 is operating under. The feedforward term Idc_ff may be measured or calculated. For example, the feedforward term Idc_ff may be measured directly from a current sensor (not shown in FIG. 2A) that measures the current flowing in the DC link 218. The feedforward term Idc_ff may be calculated based on a measured current to the load 202. The feedforward term Idc_ff allows the PI controller 384 to provide fast system response. In other words, the feedforward term Idc_ff can be considered to be a coarse adjustment to obtain Idc_ref quickly, and the PI controller 384 plays a role of fine tuning to stabilize Idc_ref over time. The value of Idc_ff may be stored on the electronic storage 234 or entered through the I/O interface 236. The control scheme 300 may be implemented without the feedforward term Idc_ff.

The output of the summing junction 386 is provided to multipliers 388d and 388q. The multiplier 388d multiples the output of the summing junction 386 with the d-axis voltage metric ( [symbol] ) from the control block 352 to determine a d-axis reference current Id_ref. The multiplier 388q multiples the output of the summing junction 386 with the q-axis voltage metric ( [symbol] ) from the control block 352 to determine a q-axis reference current Iq_ref. The d-axis reference current Id_ref and the q-axis reference current Iq_ref are input to the current controller 370.

The current controller 370 includes comparators 371d and 371q, PI controllers 372d and 372q, coupling blocks 373d and 373q, summing junctions 374d and 374q, and an output block 375. The d-axis current reference (Id_ref) and the d-axis current component (id) are provided to the comparator 374d. The d-axis current reference (Id_ref) is a reference or target value for the d-axis current that is based on the reference value of Idc_ref and accounts for the d-axis voltage metric ( [symbol] ). The d-axis current component (id) is output by the transformation block 344. The comparator 371d determines the difference (ΔId) between the d-axis current reference (Id_ref) and the d-axis current component (id) and provides (ΔId) to the PI controller 372d. The PI controller 372d regulates and reduces ΔId to a target value, which may be zero (0). The PI controller 372d may be implemented based on Equation (25):

$$\\ \begin{matrix}KpId + \frac{KiId}{s} , & Equation ( 25 )\end{matrix}$$

where KpId and KiId are gain constants that each have a numerical value that is greater than zero. The output of the PI controller 372d is a d-axis voltage reference that is provided to the summing junction 374d.

Similarly, the q-axis current reference (Iq_ref) and the q-axis current component (iq) are provided to the summing junction 374q. The q-axis current reference (Iq_ref) is a reference or target value for the q-axis current that is based on the reference value of Idc_ref and accounts for the q-axis voltage metric ( [symbol] ). The q-axis current component (iq) is output by the transformation block 344. The comparator 371q determines the difference (ΔIq) between the q-axis current reference (Iq_ref) and the q-axis current component (iq) and provides (ΔIq) to the PI controller 372q. The PI controller 372q regulates and reduces ΔIq to a target value, which may be zero (0). The PI controller 372q may be implemented based on Equation (26):

$$\\ \begin{matrix}KpIq + \frac{KiIq}{s} , & Equation ( 26 )\end{matrix}$$

where KpId and KiId are gain constants that each have a numerical value that is greater than zero. The output of the PI controller 372q is a q-axis voltage reference that is provided to the summing junction 374q.

The current controller 370 also includes the coupling blocks 373d and 373q. The d-axis current id from the transformation module 344 is input into the coupling block 373d and the q-axis current iq from the transformation module 344 is input into the coupling block 373q. The coupling blocks 373d and 373q are implemented as shown in Equation (27):

$$\\ \begin{matrix}C = ( ω L ) I , & Equation ( 27 )\end{matrix}$$

where ω is the estimated angle of the grid 201 from the angle determination block 360, L is the inductance of the converter side inductor (labeled Lf in FIG. 2A), I is the input current value (id for the coupling block 373d and iq for the coupling block 373q), and C is the output of the coupling block.

The output of the coupling block 373q is provided to the summing junction 374d, which subtracts the d-axis voltage reference Vd_ref from the output of the coupling block 373q to produce u′d, which is a d-axis voltage reference command. The output of the coupling block 373d is provided to the summing junction 374q, which subtracts the q-axis reference voltage Vq_ref from the output of the coupling block 373d to produce u′q, which is a q-axis voltage reference command. The output block 375 provides a voltage signal u′ that includes u′d and u′q to the summing junction 354. The summing junction 354 subtracts the estimated voltage ( [symbol] ) from u′ to determine a voltage control signal (u) as shown in Equation 28:

$$\\ \begin{matrix}u = {u}^{{}_{} ′} d - - ) + ( {u}^{{}_{} ′} q - - ) . & Equation ( 28 )\end{matrix}$$

The voltage control signal u is provided to a space vector pulse width modulation (SVPWM) controller 356 to generate the voltage control signal 247. The SVPWM controller 356 applies the voltage control signal 247 to the switches 215-1 to 215-6 of the rectifier 217. The voltage control signal 247 represents the opposite of the unbalance voltage at the nodes 214a, 214b, 214c. Applying the voltage control signal 247 to the electronic switches 215-1 to 215-6 causes the switches 215-1 to 215-6 to generate a waveform that cancels or compensates for voltage disturbances at the nodes 214a, 214b, 214c. In this way, the voltage unbalance at the nodes 214a, 214b, 214c is reduced or eliminated, resulting in the ripple current and ripple voltages at the energy storage apparatus 216 being suppressed or eliminated.

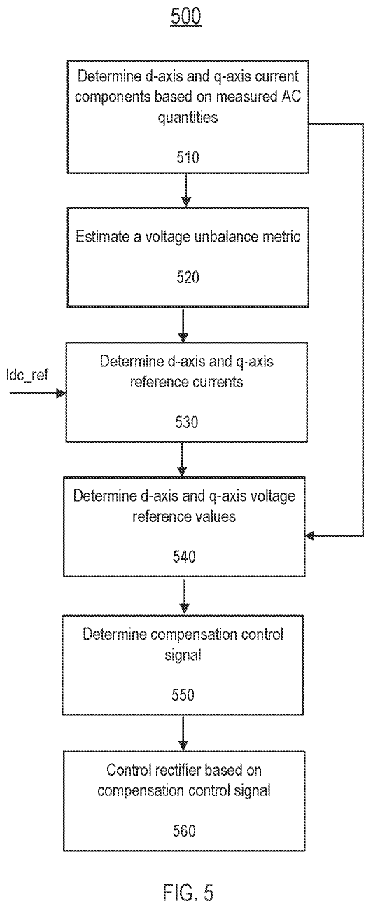

FIG. 5 is a flow chart of a process 500 for compensating for voltage unbalance. The process 500 may be implemented as a collection of instructions that are stored on the electronic storage 234 and executed by the electronic processing module 232 of the control system 230. The process 500 is discussed with respect to the power converter 210 (FIG. 2A) and the control scheme 300 (FIG. 3).

The d-axis and q-axis current components (id and iq) are determined based on measured AC quantities at the transformation block 344 (510). The current components (iq and id) are provided to the observer 350, which estimates a voltage unbalance metric (520). As discussed above, the observer 350 estimates the voltage ( [symbol] ), which is an example of the voltage unbalance metric.

The d-axis and q-axis reference currents (Id_ref and Iq_ref) are determined (530) as discussed above based on the voltage unbalance metric and the reference value of Idc. The d-axis and q-axis reference currents (Id_ref and Iq_ref) are input into the current controller 370 along with the d-axis and q-axis current components (id and iq) to determine the d-axis and q-axis voltage reference command values (u′d and u′q) (540). The compensation control signal (u) is determined by combining the d-axis and q-axis voltage reference command values (u′d and u′q) and the voltage unbalance metric (550). The compensation control signal (u) is input to the SVPWM controller 356 to determine the voltage control signal 247. The control system 230 applies the voltage control signal 247 to the rectifier 217 to control the state of the switches 215-1 to 215-6 to generate a waveform that cancels the voltage unbalance at the intermediate nodes 214a, 214b, 214c (560).

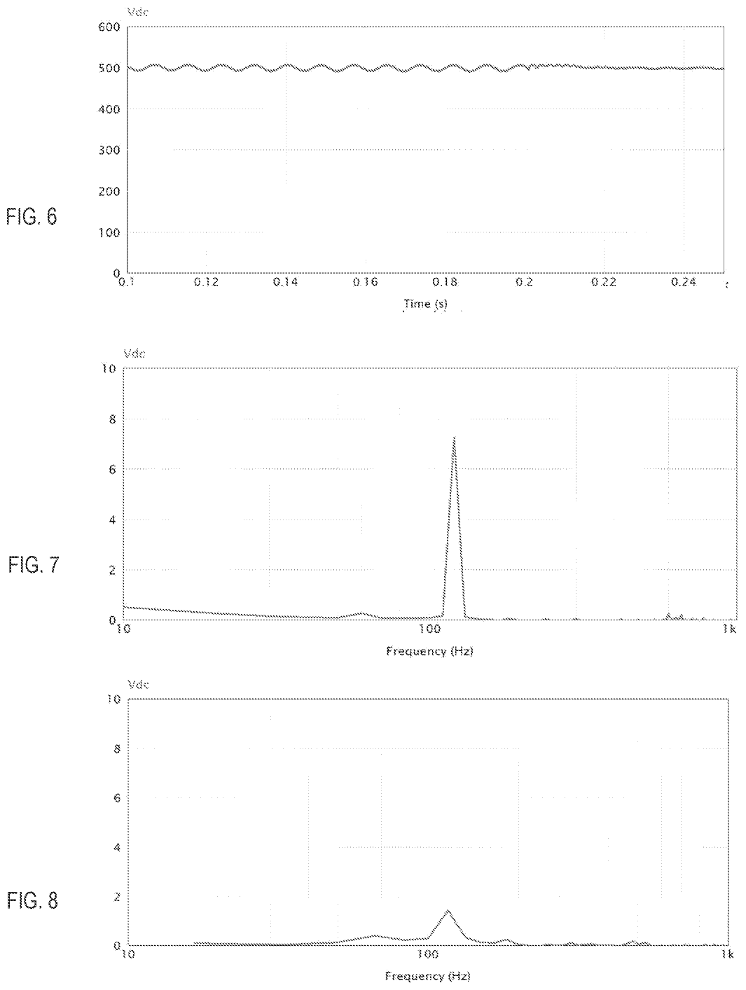

FIGS. 6-8 relate to simulated data generated during a simulation of the system 200 and the power converter 210 (FIG. 2A and 2B). In the simulation, the parameters and operating conditions were as follows: Ls=1 microhenry (μH), Rs=1 milliohm (mΩ), Lg−4.35 μH, Rg=0.435 mΩ, Lf=6 mH, Rf−0.1 ohm (Ω), Cf−0.1 μF, Rd=1 Ω, the voltage at node 272a was 170 volts (V), the voltage at node 272b was 118V, the voltage at node 272c was 170V, and the feedforward term Idc_ff was 9.2 amps (A). FIG. 6 shows Vdc, which is the voltage across the energy storage apparatus 216, in volts as a function of time (in seconds). The simulation was set up such that times prior to about 0.2 seconds did not use the control scheme 300. In other words, prior to 0.2 seconds, voltage unbalances caused by the grid were not estimated and no compensation was performed. The control scheme 300 was activated at about 0.2 seconds. The control scheme 300 performed compensation after about 0.2 seconds. As shown in FIG. 6, the ripple on Vdc was much larger prior to 0.2 seconds (when no compensation was performed) than after 0.2 seconds (when the control scheme 300 estimated and compensated for voltage unbalances).

FIGS. 7 and 8 quantify the improvement provided by the control scheme 300. FIG. 7 shows the amplitude of Vdc in volts as a function of frequency (log scale) for the times prior to 0.2 seconds in the simulation when the control scheme 300 was not active. FIG. 8 shows the amplitude of Vdc in volts as a function of frequency (log scale) for the times after 0.2 seconds in the simulation when the control scheme 300 was active. FIG. 7 shows that Vdc has a ripple, with the largest component of the ripple having an amplitude of 6.88 volts (V) at a frequency of 120 Hertz. FIG. 8 shows that the ripple in Vdc was reduced due to the application of the control scheme. As shown in FIG. 8, the largest component of the ripple is still at a frequency just above 100 Hz, but the amplitude of the ripple is less than 1.15 V. Thus, in this example, the control scheme 300 resulted in the ripple being about 17% of the original amplitude value, or 83% improvement in a key factor for extending the lifetime of the energy storage apparatus 216.

By reducing the amplitude of the ripple, the controls scheme 300 increases the lifetime of the energy storage apparatus 216, as illustrated by Equations 29-33. The RMS value for a particular ripple current harmonic component h is given by Equation (29):

$$\\ \begin{matrix}Icaph = \frac{\vert fft ( icaph ) \vert}{\sqrt{2} ( \frac{N}{2} )} , & Equation ( 29 )\end{matrix}$$

where the numerator is the absolute value of the capacitor ripple current harmonic spectrum and N is the number of time series points in the ripple current time series. The total capacitor power loss is determined based on Equation (30):

$$\\ \begin{matrix}P loss = {\sum }_{n = 1}^{Nh} {I}_{caph , n}^{2} ESR ( fn ) , & Equation ( 30 )\end{matrix}$$

where n is an integer that indexes the harmonic; Nh is the number that represents the highest harmonic in the ripple current harmonic spectrum; Icaph,n is the RMS ripple current at the nth harmonic as determined by Equation (29); and ESR(fn) is the equivalent series resistance at the frequency of the nth harmonic. The hot spot temperature of the capacitor in the energy storage apparatus 216 is determined using Equation (31):

$$\\ \begin{matrix}Th = Ta + ( P loss * Rth ) , & Equation ( 31 )\end{matrix}$$

where Th is the hot spot temperature (the hottest temperature in the capacitor) in degrees Celsius, Ploss is the power loss determined in Equation (30), Ta is the capacitor ambient temperature in degrees Celsius, and Rth is the capacitor thermal resistance. The lifetime (Lcap) of the capacitor in hours is then predicted based on Equation (32):

$$\\ \begin{matrix}L cap = A ( {2}^{{}_{} \frac{85 - Th}{c}} ) , & Equation ( 32 )\end{matrix}$$

where A and c are coefficients that are specific to a capacitor and are generally known or easily obtainable.

As shown by Equation (32), the lifetime (Lcap) decreases as the hotspot temperature (Th) of the capacitor increases. As shown by Equations (29)-(31), the hotspot temperature (Th) of the capacitor increases as the RMS value of the ripple current increases. Accordingly, by reducing the ripple current using the control scheme 300, the control system 230 increases the lifetime of the capacitor in the energy storage apparatus 216.

These and other implementations are within the scope of the claims.

What is claimed is:

1. A power converter comprising:
a filter system comprising a plurality of input nodes, each input node configured to electrically connect to one phase of a multi-phase AC electrical power distribution network;
an electrical network comprising a plurality of intermediate nodes, each intermediate node electrically connected to one phase of the filter system, the electrical network configured to convert alternating current (AC) to direct current (DC), the electrical network comprising a plurality of electronic switches;
a DC link electrically connected to the electrical network and configured to receive the DC current from the electrical network; and
a control system configured to:
estimate an unbalance metric at the intermediate nodes; and
control the electronic switches to compensate for the estimated unbalance metric to thereby reduce an amplitude of a ripple current in the DC current.

2. The power converter of claim 1, wherein the unbalance metric is an estimate of an amount of voltage unbalance.

3. The power converter of claim 1, wherein the unbalance metric comprises an estimate of a negative sequence voltage at the intermediate nodes.

4. The power converter of claim 3, wherein the unbalance metric comprises an estimate of a d-axis component of the negative sequence voltage and a q-axis component of the negative sequence voltage.

5. The power converter of claim 1, wherein the control system is further configured to:
determine a d-axis component of an AC current that flows in the intermediate nodes of the power converter; and
determine a q-axis component of an AC current that flows in the intermediate nodes of the power converter, and, wherein the control system estimates the unbalanced metric based on the d-axis component of the AC current that flows in the intermediate nodes and the q-axis component of the AC current that flows in the intermediate nodes.

6. The power converter of claim 5, wherein the control system is further configured to estimate a d-axis positive sequence voltage component, a q-axis positive sequence voltage component, a d-axis negative sequence voltage component, and a q-axis negative sequence voltage component based on the d-axis component of the AC current that flows in the intermediate nodes and the q-axis component of the AC current that flows in the intermediate nodes; and
the control system estimates the unbalanced metric based on the d-axis positive sequence voltage component, the q-axis positive sequence voltage component, the d-axis negative sequence voltage component, and the q-axis negative sequence voltage component.

7. The power converter of claim 1, wherein the electrical network comprises a rectifier, and each of the plurality of electronic switches is a transistor.

8. The power converter of claim 1, wherein the electrical network is configured to convert DC power to AC power such that the power converter is a bi-directional power converter.

9. A control system for a power converter, the control system comprising:
an observer block configured to estimate a voltage disturbance in an active front end;
a first control block configured to determine a DC reference current based on a reference voltage for an energy storage apparatus and a measured voltage across the energy storage apparatus;
a second control block configured to determine a voltage reference based on the determined DC reference current;
a junction configured to subtract the estimated voltage disturbance from the determined voltage reference to determine a voltage control signal; and
a third control block configured to generate a switch control signal based on the voltage control signal and to provide the switch control signal to an active front end to reduce a ripple current in a rectified current produced by the active front end.

10. The control system of claim 9, wherein the observer block is configured to estimate the voltage disturbance based on d-axis and q-axis component of an AC current input to the active front end, and, wherein the observer estimates the voltage disturbance in the active front end based on the d-axis and q-axis components of the AC current input to the active front end.

11. The control system of claim 10, wherein the estimate of the voltage disturbance comprises a d-axis positive sequence voltage component, a q-axis positive sequence voltage component, a d-axis negative sequence voltage component, and a q-axis positive sequence voltage component.

12. The control system of claim 9, wherein the first control block is configured to determine the voltage reference based on the reference voltage for the DC link, the measured voltage of the DC link, and a feedforward term.

13. The control system of claim 9, wherein the third control block is a space vector pulse width modulation (SVPWM) control block.

14. A method comprising:
estimating positive and negative sequence components of a voltage disturbance in a power converter, the power converter configured to provide a rectified current to an energy storage apparatus;
determining a voltage control signal based on the estimated voltage disturbance and a reference voltage;
determining a switch control signal based on the voltage control signal; and
applying the switch control signal to the power converter to thereby reduce a ripple current in the rectified current provided to the energy storage apparatus.

15. The method of claim 14, wherein the estimated voltage disturbance comprises a d-axis positive sequence voltage component, a q-axis positive sequence voltage component, a d-axis negative sequence voltage component, and a q-axis positive sequence voltage component; and the reference voltage comprising a d-axis reference voltage component and a q-axis reference component.
